(19) United States
(12) Patent Application Publication
(10) Pub. No.: US 2016/0341025 A1
(43) Pub. Date: Nov. 24, 2016

(54) SUBSEA REJECT HANDLING

(71) Applicant: FMC KONGSBERG SUBSEA AS, Kongsberg (NO)

(72) Inventors: Henrik Bjartnes, Slependen (NO); Sven Haagensen Høy, Asker (NO); Haakon Ellingsen, Oslo (NO); Jostein Kolbu, Fornebu (NO)

(21) Appl. No.: 15/112,160

(22) PCT Filed: Jan. 6, 2015
(86) PCT No.: PCT/EP2015/050090

§ 371 Date: Jul. 15, 2016

(30) Foreign Application Priority Data
Jan. 17, 2014 (NO) 20140053

(51) Int. Cl. E21B 43/36; B01D 19/00; B01D 17/06; B03C 11/00; E21B 43/40; B01D 17/02

(52) U.S. Cl. CPC E21B 43/36; E21B 43/40; B01D 17/0208; B01D 17/0217; B01D 17/06; B03C 11/00; B01D 19/0057; B01D 19/0068; B03C 2201/02

(57) ABSTRACT

The present invention provides a subsea separation system for separating a product stream, comprising: a bulk separation unit (1), an oil polishing unit (2), and a water polishing unit (3), the bulk separation unit (1) comprises an inlet (4) for the product stream, a first outlet (5) for a water phase, a second outlet (6) for an oil phase, and a third outlet for a gas phase (15); the oil polishing unit (2) comprises an inlet (7), a first outlet (8) for a clean oil phase, and a second outlet (9) for a reject stream, and the inlet is in fluid communication with the second outlet (6) of the bulk separation unit (1); the water polishing unit (3) comprises an inlet (11) in fluid communication with the first outlet (5) of the bulk separation unit, a first outlet (12) for a reject stream, and a second outlet (13) for a clean water phase, wherein a first conduit connects the second outlet (9) of the oil polishing unit upstream of, or to, the water polishing unit (3), and a second conduit connects the first outlet (12) of the water polishing unit upstream of or to, the oil polishing unit (2), and wherein the first and/or second conduit comprises a pressurizing device (14, 16) for increasing the pressure of a reject stream.

### FIELD OF THE INVENTION

The present invention concerns the field of subsea separation systems for producing oil and water More specifically, the invention provides a separation system able to provide both clean oil and clean water for injection or other disposal.

### BACKGROUND OF THE INVENTION

The product stream from subsea oil wells contains oil, gas and water. Current subsea separation systems only perform bulk separation in addition to providing a clean water phase. The clean water phase may be used for pressure support by injecting it into a reservoir. In order to transport the oil over extended distances the water content should typically be below 3% to avoid having to use excessive volumes of hydrate formation inhibitor. In a subsea context this would entail the use of large bore umbilicals, as well as high-capacity pumps, for providing the hydrate formation inhibitor. Such a system solution is highly inefficient due to the costs of large umbilicals/pumps, energy usage and large space requirement topside.

Oil reservoirs or subsea aquifers, where production water is normally deposited, usually require an oil content below 100 ppm to avoid pore clogging. Some reservoirs and aquifers require even cleaner water to remain open.

Thus, there is a need for a subsea separation system which produces both a clean oil phase and a clean water phase suitable for injection into a reservoir. Designing such a subsea system is not trivial, since there is no low pressure separator, slop tank, etc. available subsea to which a reject stream, or streams, from an oil/water separation component may be routed for additional purification/separation. Further, the system pressure needs to be maintained as high as possible to minimize any energy needed to pressurize the clean oil phase for transportation.

The aim of the present invention is a subsea separation system which provides both a clean oil phase for transportation and a clean water phase for reservoir injection.

### SUMMARY OF THE INVENTION

The invention provides a subsea separation system able to convert a subsea well product stream into a gas stream, a clean oil phase and a clean water phase. The system of the invention is further defined in the attached claims, and in the following.

In one embodiment, the invention provides a subsea separation system for separating a product stream comprising a bulk separation unit, an oil polishing unit, and a water polishing unit.

The bulk separation unit comprises an inlet for the product stream, a first outlet for a water phase, a second outlet for an oil phase, and a third outlet for a gas phase.

The oil polishing unit comprises an inlet, a first outlet for a clean oil phase, and a second outlet for a reject stream, wherein the inlet is in fluid communication with the second outlet of the bulk separation unit.

The water polishing unit comprises an inlet in fluid communication with the first outlet of the bulk separation unit, a first outlet for a reject stream, and a second outlet for a clean water phase. The system of the invention is characterized in that a first conduit connects the second outlet of the oil polishing unit upstream of, or to, the water polishing unit, and a second conduit connects the first outlet of the water polishing unit upstream of, or to, the oil polishing unit, wherein the first and/or second conduit comprises a pressurizing device for increasing the pressure of a reject stream.

Alternatively, the system of the invention may be characterized in that the second outlet of the oil polishing unit is fluidly connected upstream of, or to, the water polishing unit, and the first outlet of the water polishing unit is fluidly connected upstream of, or to, the oil polishing unit, wherein a pressurizing device for pressurizing a reject stream is arranged downstream of the second outlet of the oil polishing unit and/or the first outlet of the water polishing unit.

In one embodiment of the system of the invention, the second outlet of the oil polishing unit and/or the first outlet of the water polishing unit is connected upstream of, or to, the bulk separation unit.

In yet another embodiment of the system of the invention, a reject treatment unit is arranged downstream of at least one of the second outlet of the oil polishing unit and the first outlet of the water polishing unit, and upstream of the bulk separation unit.

In yet another embodiment of the system of the invention, gas evolved in the oil polishing unit or in the water polishing unit, during use, is pressurized separately from a liquid reject stream and returned upstream of, or to, the bulk separation unit.

In yet another embodiment of the system of the invention, a liquid level of the oil polishing unit and/or the water polishing unit is arranged such that a reject stream may be returned upstream of, or to, the oil polishing unit, the water polishing unit and/or the bulk separation unit, without the use of a pressurizing device, during use.

In yet another embodiment of the system of the invention, the oil polishing unit comprises a second inlet for receiving a reject stream during use, and a third conduit connects the first outlet of the water polishing unit with said second inlet.

In yet another embodiment of the system of the invention, a fourth conduit connects the second outlet of the oil polishing unit with the water polishing unit.

In yet another embodiment of the system of the invention, the oil polishing unit comprises a cyclonic separator device and/or a gravity separator.

In yet another embodiment of the system of the invention, the oil polishing unit comprises an inline electrostatic coalescer (IEC) arranged upstream of the cyclonic separator device and/or the gravity separator.

In yet another embodiment of the system of the invention, the water polishing unit comprises at least one cyclonic separator, and preferably two or more serially connected cyclonic separators.

In yet another embodiment of the system of the invention, the water polishing unit comprises at least one further element suitable for separating oil from water, such as a flotation unit, a membrane separator or a gravity separator, wherein said element is arranged downstream of the cyclonic separator(s).

In yet another embodiment of the system of the invention, the clean water phase is suitable for injection into a reservoir during use, and preferably contains less than 100 ppm oil.

In yet another embodiment of the system of the invention, the clean oil phase is suitable for transport during use, and preferably contains less than 3% water by volume.

In yet another embodiment of the system of the invention, the reject treatment unit comprises at least one component which during use will provide an enhanced separation of individual phases of a reject stream when returned to the bulk separator, wherein the enhanced separation is obtained by, for instance, chemical injection, heating and/or droplet coalescing.

In yet another embodiment of the system of the invention, at least part of the clean oil phase is pressurized by a pressurizing device, such as a pump or ejector.

In a further aspect, the invention provides a method for subsea separation of a product stream, comprising the steps of:
leading the product stream to a bulk separation device, wherein the product stream is separated into a water phase, an oil phase and a gas phase;
leading the water phase to a water polishing unit and obtaining an oil reject stream and a clean water phase, wherein the clean water phase is suitable for injection into a reservoir and preferably contains less than 100 ppm oil;
leading the oil reject stream upstream of at least part of the oil polishing unit;
leading the oil phase to an oil polishing unit and obtaining a water reject stream and a clean oil phase, wherein the clean oil phase suitable for long distance oil transport and preferably contains less than 3% water by volume; and
leading the water reject stream upstream of at least part of the water polishing unit.

In the context of the present invention, the term “clean oil phase” is intended to mean an oil phase comprising typically less than 3% of water by volume, and the term “clean water phase” is intended to mean a water phase comprising less than 100 ppm by volume of oil.

The term “water polishing” is intended to mean a process wherein a water phase is purified by removing oil until the water contains less oil than required for injection, for example 100 ppm.

The term “oil polishing” is intended to mean a process wherein an oil phase is further purified by removing water until the oil contains less water than required, typically below 3%.

The term “pressurizing device” is intended to mean any suitable type of device able to increase the pressure of a fluid flow, such as a pump, an ejector or a compressor.

### BRIEF DESCRIPTION OF THE DRAWINGS

FIG. 1 is a schematic drawing of one embodiment of a system according to the invention, wherein the reject streams are returned to the bulk separator.

FIGS. 2 and 3 are schematic drawings of two additional embodiments of a system according to the invention, wherein the reject streams are not returned to the bulk separator.

FIG. 4 is a detailed schematic drawing of another embodiment of a separation system according to the invention.

### DETAILED DESCRIPTION OF THE INVENTION

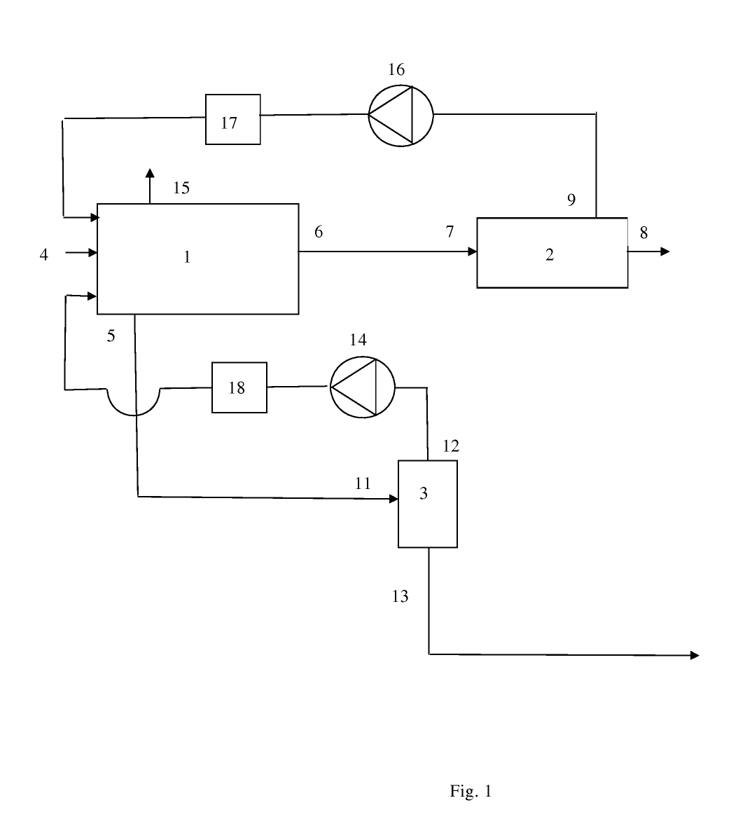

A first embodiment of a system according to the invention is shown in FIG. 1. The system comprises a bulk separator unit 1 having a first inlet 4 for a product stream. The bulk separator unit is able to separate the product stream into three phases: a gas phase (outlet 15), a water phase (outlet 5), and an oil phase (outlet 6). The bulk separator unit is fluidly connected to an oil polishing unit 2 and a water polishing unit 3 by conduits, such as pipes. The oil polishing unit 2 may comprise various components for separating residual water from the oil phase received from the bulk separator 1. Such oil polishing components are well known to the skilled person and examples of such are given below. The oil polishing unit provides a clean oil phase (outlet 8) suitable for transportation and a reject stream (outlet 9). The reject stream (throughout this specification the reject stream from the oil polishing unit is also termed a water reject stream even if it is not necessarily water continuous), comprising water and a significant amount of oil, is returned to, or upstream of, the bulk separation unit. Before being returned to the bulk separation unit 1, the pressure of the reject stream is boosted by a pressurizing device 16, e.g. a pump or ejector, and submitted to a reject treatment unit 17. A pump is commonly preferred for boosting the pressure of the reject stream from the oil polishing unit since the required ejector motive fluid may pollute or greatly increase the volume of said stream. If gas is evolved in the oil polishing unit 2, the pump may be a multiphase pump if a compressor is not selected for boosting of the gas. The oil polishing unit 2 may, for instance, include a water droplet coalescing device and a cyclonic or gravitational separator. A separation outlet from the reject treatment unit 17 is not indicated in the figure, as this unit is for pre-treatment of the reject stream. This treatment may comprise chemical injection, heating, a droplet coalescing device, etc to enhance separation of the individual phases returned to the bulk separator 1.

The water polishing unit 3 may comprise various components for separating residual oil from the water phase received from the bulk separator 1. Such water polishing components are well known to the skilled person and examples of such are given below. The water polishing unit provides a clean water phase (outlet 13) suitable for injection into a reservoir, and a reject stream (outlet 12). The reject stream (throughout this specification the reject stream from the water polishing unit is also termed an oil reject stream even if it is not necessarily oil continuous), comprising oil and a significant amount of water, is returned to, or upstream of, the bulk separation unit. Before being returned to the bulk separation unit 1, the pressure of the reject stream from the water polishing unit is boosted by a pressurizing device 14, e.g. a pump or ejector, and submitted to a reject treatment unit 18. This unit may provide similar pre-treatment as in the reject treatment unit 17 for the water reject stream.

The product stream will often contain some gas, and the bulk separation unit commonly comprises a gas outlet 15 for separating the gas from the water and oil phases.

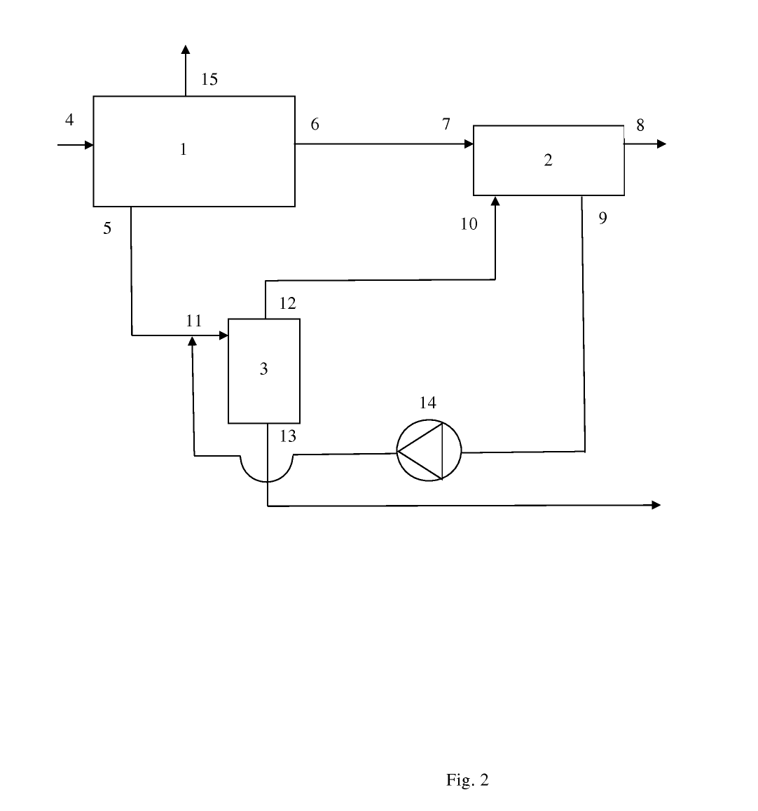

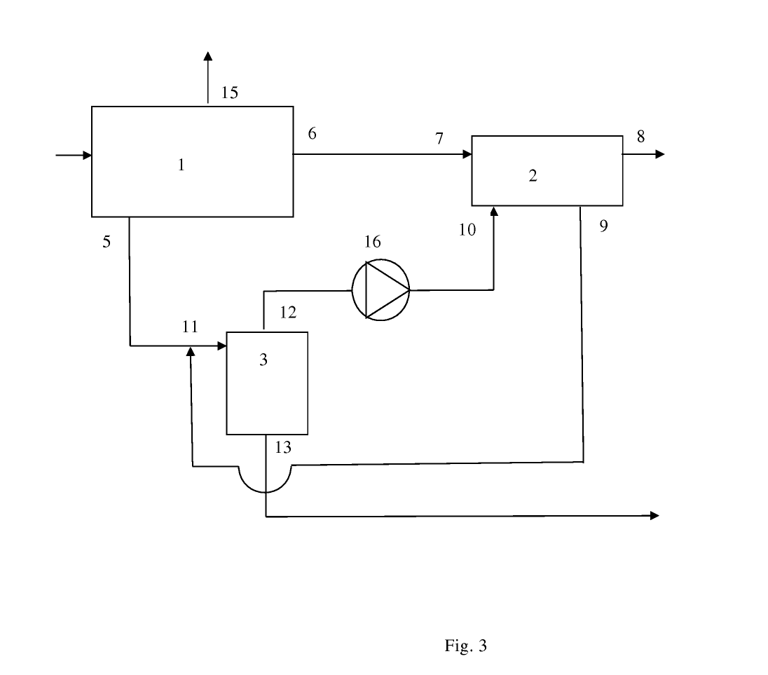

Two similar separation systems are shown in FIGS. 2 and 3. As opposed to the system shown in FIG. 1, the reject streams (from outlets 12 and 9) of the systems in FIGS. 2 and 3 are not returned to the bulk separation unit 1. In both systems, the reject stream from the oil polishing unit 2 (i.e., the water reject stream) is led to, or upstream of, the water polishing unit 3 for further treatment. Likewise, the reject stream from the water polishing unit 3 (i.e., the oil reject stream) is led to, or upstream of, the oil polishing unit 2 for further treatment. Some unavoidable loss of fluid pressure will always occur. To compensate for the pressure loss, the pressure of either the water reject stream 9 or the oil reject stream 12 is boosted by a pressurizing device 14, 16. Both pressurizing devices 14 and 16 may be employed in one system if required. The difference between the systems of FIGS. 2 and 3 lies in which reject stream is being boosted, the water reject stream 9 in FIG. 2 or the oil reject stream 12 in FIG. 3. Both separation systems shown in FIGS. 2 and 3 provide a clean oil phase (outlet 8) and a clean water phase (outlet 13).

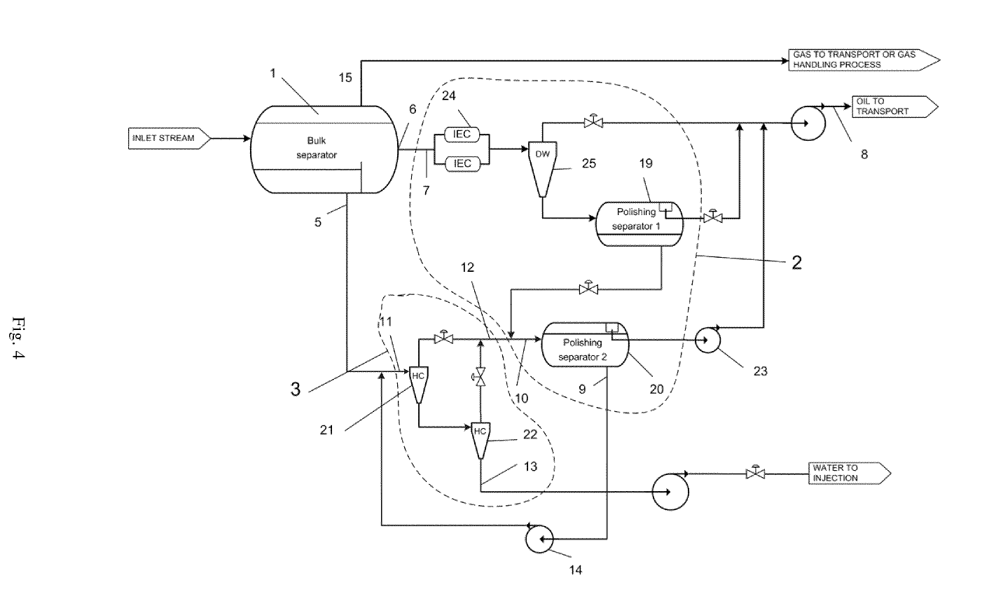

A more detailed schematic drawing of a separation system is shown in FIG. 4. Similar to the system of FIG. 2, the pressure of the water reject stream is boosted by a pressurizing device 14, which in this system comprises a pump. In this embodiment, the oil polishing unit 2 (encircled by a dashed line) comprises an inline electrostatic coalescer (IEC) 24, a cyclonic separator 25, and two gravity separators 19, 20. The oil phase from the bulk separation unit is first passed through the IEC. The IEC promotes water-in-oil droplet growth, making the subsequent separation in the cyclonic separator 18 and the gravity separators 19, 20 more efficient. The cyclonic separator splits the oil phase into a first clean oil phase for transportation and a first water reject stream. The first cyclonic separator reject stream is led to a first gravity separator 19, which provides a second clean oil phase and a second water reject stream. The second reject stream is subsequently led to the second gravity separator and commingled with the oil reject stream from the water polishing unit 2 to provide a third clean oil phase and a third water reject stream. The collected clean oil phases are transported to the production line, and the third water reject stream exits the outlet 9. The water polishing unit 3 (encircled by a dashed line) comprises two cyclonic separators 21, 22 arranged in series. The third water reject stream exiting the outlet 9 in the oil polishing unit 2 is led to the water polishing unit, where it enters the first of the cyclonic separators 21. In this case, the third water reject stream is connected to the first of the serially arranged cyclonic separators but may in other embodiments bypass the first cyclonic separator and only enter the second cyclonic separator 22. The latter configuration may be advantageous when the third water reject stream is sufficiently clean to only require passing through a single cyclonic separator to obtain a clean water phase. Note that the two polishing separators 19, 20 may be combined into one single unit, thereby reducing the number of components. In the present system, a pump 23 is used to pressurize at least part of the clean oil phase.

All of the embodiments shown in FIGS. 1-3 comprise a water polishing unit 3 and an oil polishing unit 2. The water polishing unit may comprise various components suitable for separating residual oil from a water phase. The need for pressure increasing devices 14, 16 depends on the arrangement of the components of the polishing units, their respective pressure drops, and where the reject streams 9 and 12 are introduced to the polishing units 3 and 2, respectively.

Water polishing components include, e.g., cyclonic separators such as hydrocyclones, flotation units, membrane separators and gravity separators. The order in which these components are arranged, when the water polishing unit comprises more than one component, may vary but is usually decided by their capacity for removing oil, i.e. the component with the highest capacity, e.g. a cyclonic separator, is arranged upstream of those components having a lower capacity, e.g. a membrane separator. Such components and their arrangement are well known to the persons skilled in the art of separation technology.

The oil polishing unit may comprise various components suitable for separating residual water from an oil phase. Such oil polishing components include cyclonic separators, inline electrostatic coalescers (IECs) and gravity separators. The oil phase may first be led through an IEC to facilitate the separation in the cyclonic separator(s) and/or gravity separator(s). In both the water polishing unit and the oil polishing unit, the various components may be arranged in parallel and/or series to obtain the desired effect, i.e. an increased throughput capacity, increased separation efficiency, or increased system robustness. All components, both oil polishing components and water polishing components, must be suitable for high pressure separation and environments.

A common feature of all the embodiments shown in FIGS. 1-4 is that the reject stream from the oil polishing unit and the reject stream from the water polishing unit are led upstream of, or to, the water polishing unit or oil polishing unit, respectively. This feature results in a subsea separation system able to provide both a clean oil phase for transportation and a clean water phase suitable for injection into a reservoir.

1. A subsea separation system for separating a product stream, the subsea separation system comprising:
a bulk separation unit;
an oil polishing unit; and
a water polishing unit;
the bulk separation unit comprising an inlet for the product stream, a first outlet for a water phase, a second outlet for an oil phase, and a third outlet for a gas phase;
the oil polishing unit comprising an inlet in fluid communication with the second outlet of the bulk separation unit, a first outlet for a clean oil phase, and a second outlet for a reject stream;
the water polishing unit comprising an inlet in fluid communication with the first outlet of the bulk separation unit, a first outlet for a reject stream, and a second outlet for a clean water phase;
wherein a first conduit connects the second outlet of the oil polishing unit upstream of, or to, the water polishing unit, and a second conduit connects the first outlet of the water polishing unit upstream of, or to, the oil polishing unit, and wherein at least one of the first and second conduits comprises a pressurizing device for increasing the pressure of a corresponding reject stream.

2. A subsea separation system according to claim 1, wherein at least one of the second outlet of the oil polishing unit and the first outlet of the water polishing unit is connected upstream of, or to, the bulk separation unit.

3. A subsea separation system according to claim 1, wherein a reject treatment unit is arranged upstream of the bulk separation unit and downstream of at least one of the second outlet of the oil polishing unit and the first outlet of the water polishing unit.

4. A subsea separation system according to claim 1, wherein gas evolved in the oil polishing unit or the water polishing unit is pressurized separately from the corresponding reject stream and returned upstream of, or to, the bulk separation unit.

5. A subsea separation system according to claim 1, wherein a liquid level of at least one of the oil polishing unit and the water polishing unit is arranged such that the corresponding reject stream may be returned upstream of, or to, the oil polishing unit, the water polishing unit or the bulk separation unit, without the use of a pressurizing device.

6. A subsea separation system according to claim 1, wherein the oil polishing unit comprises a second inlet for receiving a reject stream during use and the subsea separation system includes a third conduit which connects the first outlet of the water polishing unit with said second inlet.

7. A subsea separation system according to claim 1, wherein a fourth conduit connects the second outlet of the oil polishing unit with the water polishing unit.

8. A subsea separation system according to claim 1, wherein the oil polishing unit comprises at least one of a cyclonic separator device, and a gravity separator.

9. A subsea separation system according to claim 1, wherein the water polishing unit comprises at least one cyclonic separator.

10. A method for subsea separation of a product stream, comprising the steps of:
leading the product stream to a bulk separation device, wherein the product stream is separated into a water phase, an oil phase and a gas phase;
leading the water phase to a water polishing unit and obtaining an oil reject stream and a clean water phase, the clean water phase being suitable for injection into a reservoir;
leading the oil reject stream upstream of at least part of the oil polishing unit;
leading the oil phase to an oil polishing unit and obtaining a water reject stream and a clean oil phase, the clean oil phase being suitable for long distance oil transport; and
leading the water reject stream upstream of at least part of the water polishing unit.

11. A subsea separation system according to claim 8, wherein the oil polishing unit comprises an inline electrostatic coalescer (IEC) arranged upstream of said at least one of the cyclonic separator device and the gravity separator.

12. A subsea separation system according to claim 9, wherein the water polishing unit comprises two or more serially connected cyclonic separators.

13. The method of claim 10, wherein the clean water phase obtained from the water polishing unit contains less than 100 ppm oil.

14. The method of claim 10, wherein the clean oil phase obtained from the oil polishing unit contains less than 3% water by volume.
